(19) United States
(12) Patent Application Publication
(10) Pub. No.: US 2017/0321999 A1
(43) Pub. Date: Nov. 9, 2017

(54) LAYERED GRAPHIC DECAL ARROW AND METHOD OF MANUFACTURE

(71) Applicant: ALDILA GOLF CORP., Poway, CA (US)

(72) Inventor: Keith Hoefer, San Diego, CA (US)

(21) Appl. No.: 15/451,597

(22) Filed: Mar. 7, 2017

Related U.S. Application Data
(60) Provisional application No. 62/305,920, filed on Mar. 9, 2016.

(51) Int. Cl. F42B 6/04; B32B 37/10; B32B 37/08; B44C 1/175; B32B 37/12

(52) U.S. Cl. CPC F42B 6/04; B44C 1/1756; B32B 37/12; B32B 37/08; B32B 37/10; B32B 2405/00

(57) ABSTRACT

The layered graphic decal arrow consists of an arrow base, decal, and a finishing layer. Two separate curing processes are used to create the arrow to prevent adhesive from penetrating the decal thereby degrading the visual appeal of the arrow. The decal is applied to the arrow base, or printed on the arrow base, then flashed at a first temperature then cured at a second temperature. After cooling the arrow, a finishing layer is applied to the arrow. A uniform pressure is applied around the finishing layer to hold it in place while curing. After curing, the uniform pressure is removed, the arrow is polished to remove undesired markings and the arrow is cut to the desired length. In an alternative embodiment, the finish layer is a polymer coating applied to the arrow without the need for uniform pressure.

### RELATED APPLICATIONS

This application claims the benefit of priority to U.S. Provisional Application Ser. No. 62/305,920 entitled “Layered Graphic Decal Arrow and Method of Manufacture” filed on Mar. 9, 2016, and currently co-pending.

### FIELD OF THE INVENTION

The present invention relates generally to archery arrows, and more specifically to a process to produce a layered graphic decal arrow. The present invention is more particularly, though not exclusively, useful as a process to incorporate multiple layers onto an arrow base resulting in a finished layered graphic decal arrow body.

### BACKGROUND OF THE INVENTION

Archery arrows have been in use for centuries. Over this time period, significant improvements have been made in the design of the arrows. For instance, the materials used for arrows have evolved from ancient arrows made of wood to modern arrows fabricated using lightweight high strength carbon fiber composites. Also, the Fletching, or Finning, has evolved from a standard X-shape feather to an aerodynamic three-tab design which minimizes contact with the bow and improves accuracy. Improvements have also been made to the arrow head to improve aerodynamics and to the nock to decrease weight, for instance.

The shaft is the primary structural element of the arrow, to which the other components are attached. Shafts of arrows are typically composed of solid wood, fiberglass, aluminum alloy, carbon fiber, or composite materials such as carbon composites. Modern arrows are typically made from a carbon fiber arrow shaft that is hollow, and include a point in the front of the arrow shaft, a nock in the rear of the arrow shaft, and fletching along the surface of the arrow shaft adjacent the nook. In flight, the hollow arrow shaft flexes slightly along its length in an oscillatory motion due to the forces applied to the arrow when it is fired from a bow. The ability of an arrow to absorb and manage these forces directly affects the accuracy and precision of the arrow.

Camouflaged arrows have been in use by archers for many years. Camo arrows are typically used during outdoor hunting to allow a hunter to remain unseen while waiting for a target to enter that hunters area. Typical prey becomes aware of movement and sound when in close enough proximity. While stalking prey, if the hunter and the hunters equipment is not adequately camouflaged, the prey may become aware of the hunter's presence and attempt to flee, thereby thwarting the hunter's efforts. Many of the arrows available today are brightly colored and may have shinny or reflective surfaces. These colors and reflections may alert the prey to the hunters presence causing the prey to flee and reducing the probability that the hunter will successfully capture or kill the prey. To overcome the issue of alerting the prey, camouflaged arrows have been developed. Some of these arrows achieve the desired effect through the choice of color and surface finishes.

In modern arrow manufacturing, some manufacturers apply a camouflaged decal to the length of the arrow surface. This allows the manufacturer greater flexibility in the type of materials used to create the arrow body as well as provide the manufacturer more camouflage design choices. However, the decals used suffer from fraying along the seam as well as at the ends of the arrow body. Further, the decal surfaces are more susceptible to cuts, nicks, scratches, and general abrasion that may result in the decal detaching from the arrow surface.

Also in modern manufacturing, some manufacturers apply a decal to an arrow base then apply a scrim layer over the decal. This arrow is then cured. However, this process may result in the adhesive from the decal or the adhesive from the scrim layer to penetrate through the decal and bonding with the other layer's adhesive causing a visual defect in the arrow that cannot be removed.

In light of the above, it would be advantageous to provide a process of applying and curing a decal to an arrow body, then applying and curing a separate finishing layer that only requires polishing to result in a quality camouflaged arrow that resists chipping and peeling.

### SUMMARY OF THE INVENTION

The present invention consists of a process for producing a layered graphic decal arrow body. After a suitable arrow base is chosen, the base is ground to the proper desired dimensions. Application of an adhesion promoter may or may not be required. Next, a decal is applied to the length of the arrow shaft and aligned such that the seam runs linearly along the length of the shaft. After the decal is properly applied to the arrow shaft, it is cured until the decal is adhered to the outside surface of the arrow body. After curing, the arrow is inspected for defects. If none are found, then a finishing layer is applied over the decal. A uniform pressure is applied, such as by the use of cellophane-like material wrapped over the finishing layer, to hold the finishing layer in place. The arrow is then cured again until the finishing layer has fully adhered to the decal. After it is cured, the cellophane-like wrap is removed. The arrow is then polished to remove only the marks left by the cellophane-like wrapping. After polishing, the arrow is ready to have any remaining items, such as a tip and fletching, added to create a complete arrow.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an arrow base having an unfinished exterior;

FIG. 2 is a side view of a solvent solution inside a container. A camouflaged decal mounted to a backing is shown submerged in the solvent solution to prepare the decal for application to the arrow base;

FIG. 3 is a perspective view of an arrow base placed along the edge of a decal after being submerged in the solvent solution. The decal will be transferred from the backing to the exterior of the arrow base by rotating the base such that it rolls along the width of the decal;

FIG. 4 is a perspective view of the arrow base from FIG. 3 after it has been rolled such that the decal has been fully transferred to the arrow base;

FIG. 5 is a perspective view of an arrow with camouflaged decal applied. A hand is shown with the index finger and thumb wrapped around the shaft such that when the hand is slid in a direction, any bubbles and imperfections will be pressed out resulting in a smooth decal surface;

FIG. 6 is a perspective view of an arrow with decal placed along the edge of a finishing layer. The finishing layer will be transferred to the arrow by rotating the arrow such that the arrow rolls along the width of the finishing layer;

FIG. 7 is a perspective view of an arrow with a finishing layer having a cellophane-like material wrapped around the arrow;

FIG. 8 is an exemplary flow chart showing the process steps used to create the camouflaged arrow;

FIG. 9 is a continuation of the exemplary flow chart showing the process steps used to create the camouflaged arrow;

FIG. 10 is an exemplary flow shat of apply a polymer layer to an arrow shaft; and

FIG. 11 is a flow chart showing an alternative process of the present invention.

### DETAILED DESCRIPTION

The invention described herein provides an improvement in the archery industry where a layered graphic decal arrow is created having a finishing layer applied that covers any seams resulting from production and provides added protection from cuts, chips, scratches, and abrasions.

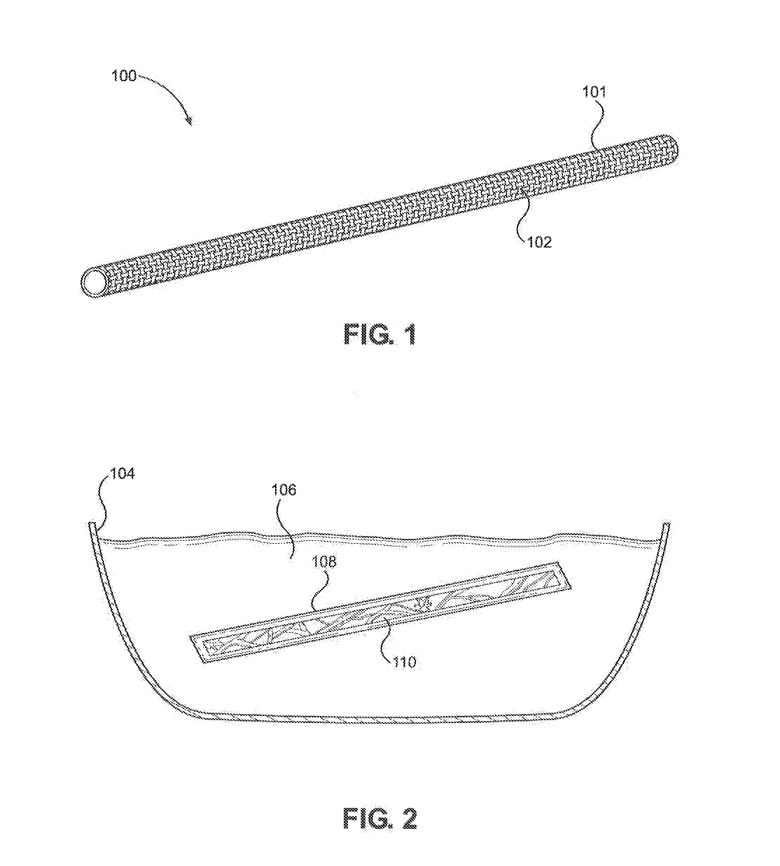

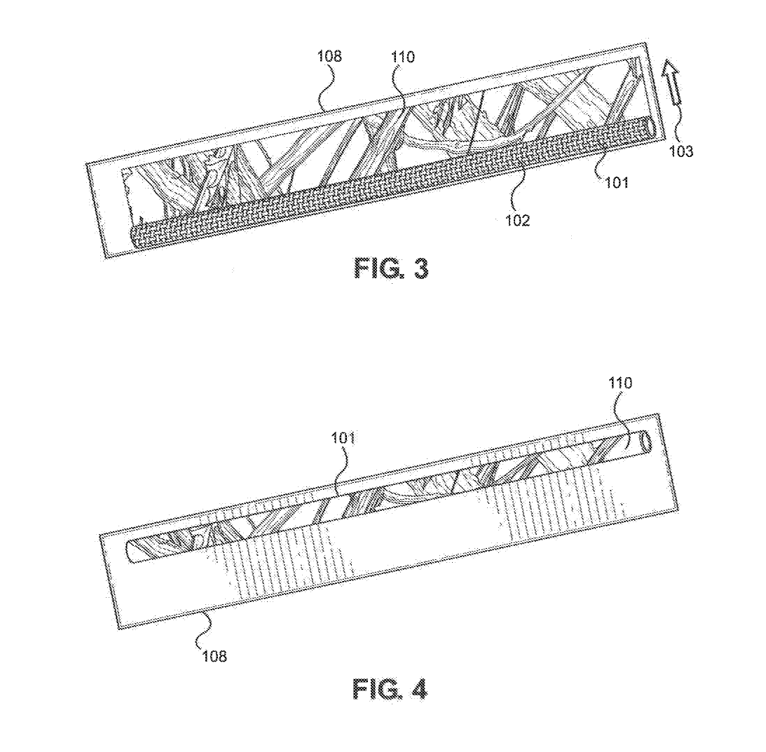

Referring to FIG. 1, a perspective view of an arrow is shown and designated 100. Arrow 100 consists of an arrow base 101 having an unfinished exterior 102. In a preferred embodiment, Arrow base 101 is made from a carbon fiber material or a composite material consisting in part of carbon fiber. However, other materials, such as wood and aluminum, are fully contemplated without departing from the spirit of the invention. Due to the nature of carbon fiber, exterior surface 102 of arrow base 101 is unfinished and contains surface irregularities, which may cause the arrow base 101 to exceed the dimensions required for a finished arrow 100. To prepare arrow base 101 for receiving a decal (not shown, See FIG. 3), exterior surface 102 is ground to remove imperfections and to meet the desired physical properties, such as diameter and spine stiffness.

FIG. 2 is a side view of a solvent solution 106 within a container 104, showing a decal 110, mounted to decal backing 108, submerged in solvent solution 106. In a preferred embodiment, solvent solution 106 consists of eighteen (18) parts water to one (1) part solvent. Decal 110 and decal backing 108 are submerged until both are thoroughly wet, typically 5-10 seconds. It is to be appreciated by one skilled in the art that the type and concentration of solvent used, as well as soak times, may vary depending on the type of decal and adhesive used. If decal 110 and decal backing 108 are soaked to the point that decal 110 detaches or starts to detach from decal backing 108, decal 110 and decal backing 108 are no longer usable and should be discarded. Decal backing 108 remains with decal 110 when it is pulled from the water. The decal 110 is rolled off the backing and then the backing 108 is discarded. This is described in the following paragraphs.

FIG. 3 is a perspective view of arrow base 101, with unfinished exterior surface 102, aligned along the edge of decal 110. Firm downward pressure is applied to arrow base 101 to adhere decal 110 to arrow 100. Next, arrow base 101 is rotated, maintaining firm downward pressure, such that arrow base 101 rolls in direction 103, thereby adhering decal 110 such that it covers exterior surface 102 of arrow base 101. While arrow base 101 is being rotated, decal 110 detaches from decal backing 108.

FIG. 4 is a perspective view of arrow 100 after rolling decal 110 onto exterior surface 102 (not shown) of arrow base 101. As described above in relation to FIG. 3, decal 110 has completely detached from decal backing 108. As can be seen in FIG. 4, decal 110 has a camouflage pattern and is now fully visible. The use of a camouflage pattern on decal 110 is not meant to be limiting and it is contemplated that any type of graphic may be imprinted on the decal such as wood grain, carbon fiber weave, or any other type of graphic design.

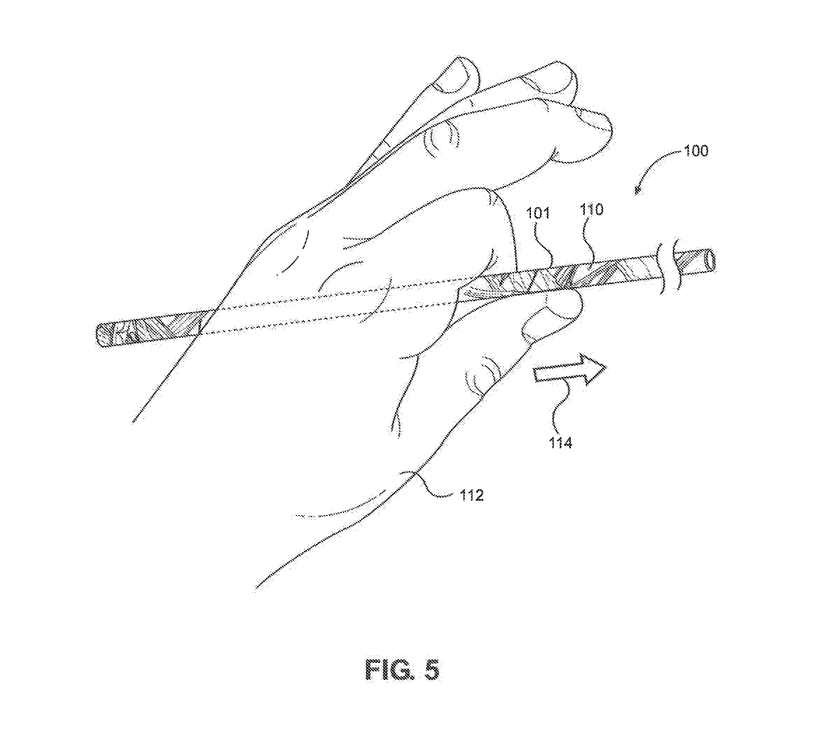

FIG. 5 is a perspective view of arrow 100 having decal 110 applied, showing a hand 112 with its index finger and thumb wrapped around arrow 100 such that a tight seal is formed between the fingers and arrow 100. Hand 112 is then slid along arrow 100 in direction 114 to remove any bubbles and imperfections from decal 110.

After the bubbles and imperfections are removed, arrow 100 is cleaned to remove impurities and solvent. Arrow 100 is then inspected for defects. If any exist, decal 110 is removed then a new decal applied. The defect free arrow 100 is then flashed at a first temperature for thirty (30) minutes, followed by curing at a second temperature for one (1) hour. In a preferred process, the first temperature is 140° F. and the second temperature is 210° F. After curing, arrow 100 is cooled to ambient temperature then inspected for defects. If defects are found, arrow 100 is rejected.

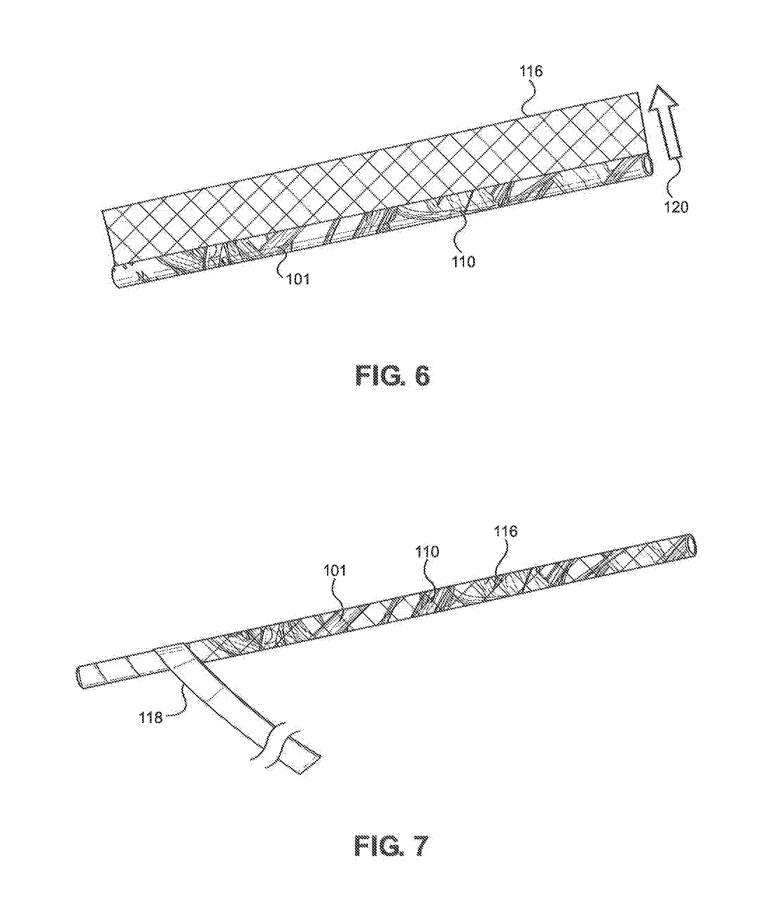

FIG. 6 is a perspective view of decal 110 cured onto arrow 100, then aligned with a finishing layer 116. A section of finishing layer 116 is cut to the desired dimensions and placed on a flat surface. Arrow 100 is aligned along the edge of finishing material 116 then rotated such that arrow 100 rolls in direction 120, thereby causing finishing layer 116 to fully cover decal 110. It is to be appreciated by someone skilled in the art that finishing layer 116 will become transparent when cured. After finishing layer 116 is fully applied to arrow 100, finishing layer 116 is inspected for defects. If any defects are found, finishing layer 116 is removed then reapplied until no defects are found.

FIG. 7 is a perspective view of arrow 100 with decal 110 wrapped in finishing layer 116. Cello film 118 is then wrapped around arrow 100 over finishing layer 116 until finishing layer 116 is completely covered. Cello film 118 holds finishing layer 116 in place during the curing process. Arrow 100 with finishing layer 116 wrapped in cello film 118 is then cured at a temperature for one (1) hour, and then cooled to ambient.

After arrow 100 is cooled to ambient, cello film 118 is fully removed. The nature of cello film 118 is to leave behind marks on the cured finishing layer 116. Arrow 100 is then polished such that only the marks from cello film 118 are removed leaving finishing layer 116 smooth and intact. If arrow 100 is polished excessively, finishing layer 116 may be removed in some areas causing those areas to “fuzz up”, or even remove a portion of decal 110, thereby degrading the finished look of arrow 100 and possibly causing finished arrow 100 to be rejected.

In an alternative embodiment, a contracting sleeve may be used to impart uniform pressure against the arrow 100 with decal 110 wrapped in finishing layer 116. The uniform pressure created by the contracting sleeve ensures the decal 110 wrapped in finishing layer 116 on the arrow 100 is held in place during the curing process. Arrow 100 with finishing layer 116 wrapped in the contracting sleeve is then cured at a temperature for one (1) hour, and then cooled to ambient. The contracting sleeve used may be made of silicone or any other material with contracting characteristics.

In another alternative embodiment, a pressure vessel may be used to impart uniform pressure against the arrow 100 with decal 110 wrapped in finishing layer 116. The uniform pressure created by the pressure vessel ensures the decal 110 wrapped in finishing layer 116 on the arrow 100 is held in place during the curing process. Arrow 100 with finishing layer 116 in the pressure vessel is then cured at a temperature for one (1) hour, and then cooled to ambient. The pressure vessel may be a pressure curing oven, an autoclave, a heated press, or any similar type of device that imparts pressure and heat to an object.

It is to be appreciated by someone skilled in the art that use of two (2) distinct curing processes, one to cure decal 110 onto arrow base 101, the other to cure finishing Dyer 116 onto decal 110, prevents the adhesive of finishing layer 116 from penetrating decal 110 and adhering to decal's 110 adhesive, thereby degrading the quality of the camouflage pattern of arrow 100. If the adhesive of one layer was to penetrate through the decal 110 and bond with the adhesive of the other layer, a dull spot will be formed on the finished arrow 100.

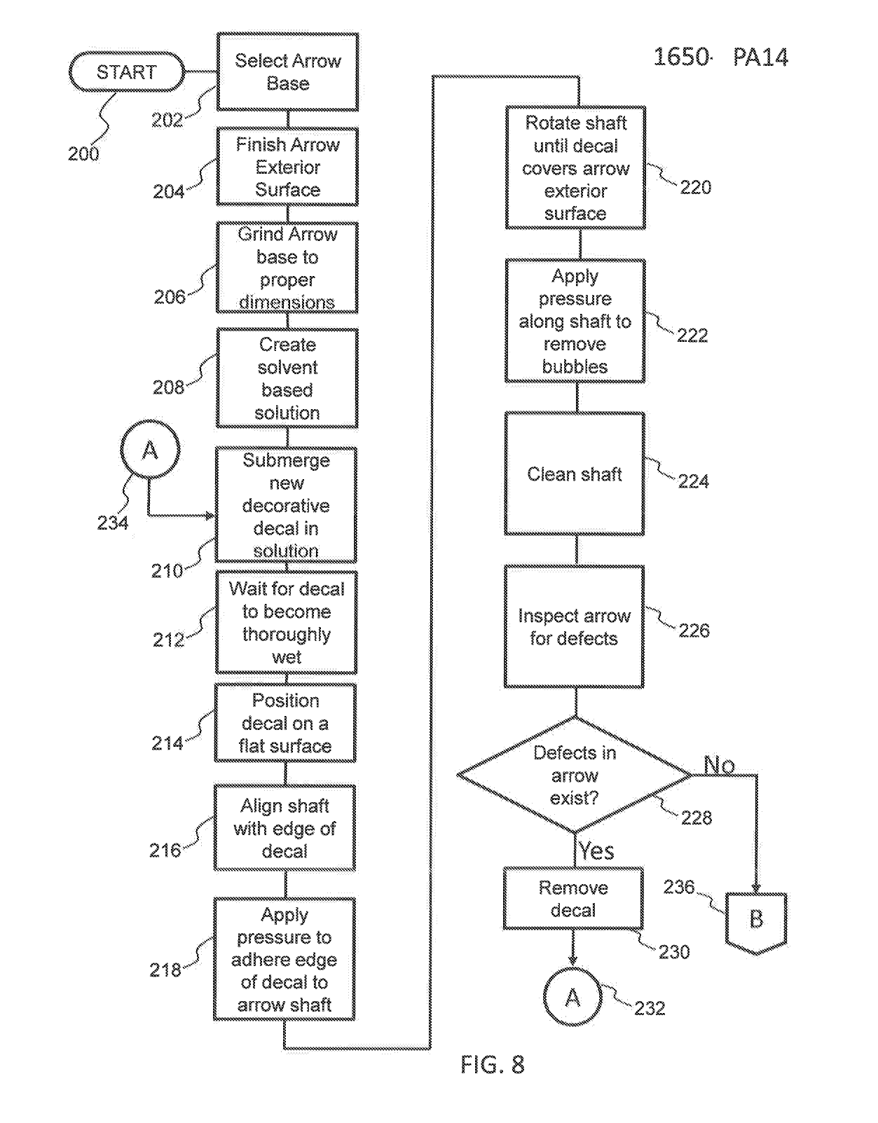

Referring now to FIG. 8, a flow chart of an exemplary process of the present invention is shown. The process starts at step 200. In step 202, an arrow base 101 is selected. In step 204, the selected arrow base 101 is ground to the proper dimensions. Next, a solvent based solution 106 is created in step 208. In a preferred embodiment, 16-18 parts water is combined with one (1) part solvent to create solution 106. In step 210, a new decorative decal 110 with decal backing 108 is submerged in solution 106. In step 212, both decal 110 and decal backing 108 are submerged until both become thoroughly wet. In a preferred embodiment, decal 110 and decal backing 108 are submerged for 5-10 seconds. However, differing decals 110 may require the use of solutions 106 containing different solvents at different concentrations and wetted for different periods of time and are fully contemplated. Further, decal 110 may only require water or solvent instead of both to prepare it for use.

In step 214, the wetted decal 110 is placed on a flat surface. In a preferred embodiment of the process, decal 110 may be placed on a sheet of foam, such as Styrofoam, or any other material that conforms to the shape of a surface pressed upon it and which provides adequate friction to prevent the surface pressed upon it from movement, such as decal backing 108. Step 216 has arrow base 101 aligned with a lengthwise edge of decal 110. In step 218, downward pressure is applied to arrow base 101 to adhere decal 110 to arrow base 101. In step 220, arrow base 101 is then rolled in direction 103 until decal 110 is fully transferred from decal backing 108 to arrow base 101 thereby covering exterior surface 102 of arrow base 101.

After transferring decal 110 to arrow base 101, step 222 has pressure applied along the length of the arrow 100 to remove bubbles and imperfections in decal 1110. Arrow 100 consists of arrow base 101 with decal 110 applied to it. In a preferred process, an index finger and thumb of hand 112 are wrapped tightly around arrow 100, then slid in direction 114 to remove bubbles and imperfections. However, use of a tool that forms a seal around arrow 100 that can be slid along the length of arrow 100 to remove bubbles and imperfections is fully contemplated. Step 226 then has arrow 100 inspected for defects. If defects exist in arrow 100, step 228 directs the process to step 230, which has the decal 110 removed from arrow base 101. Step 230 directs the process to connector 232, which in turn directs the process to connector 234. Connector 234 directs the process back to step 210 to have a new decal 110 prepared for application to arrow base 101. If no defects exist in arrow 100, step 228 directs the process to off-sheet connector 236, which connects to off-sheet connector 238.

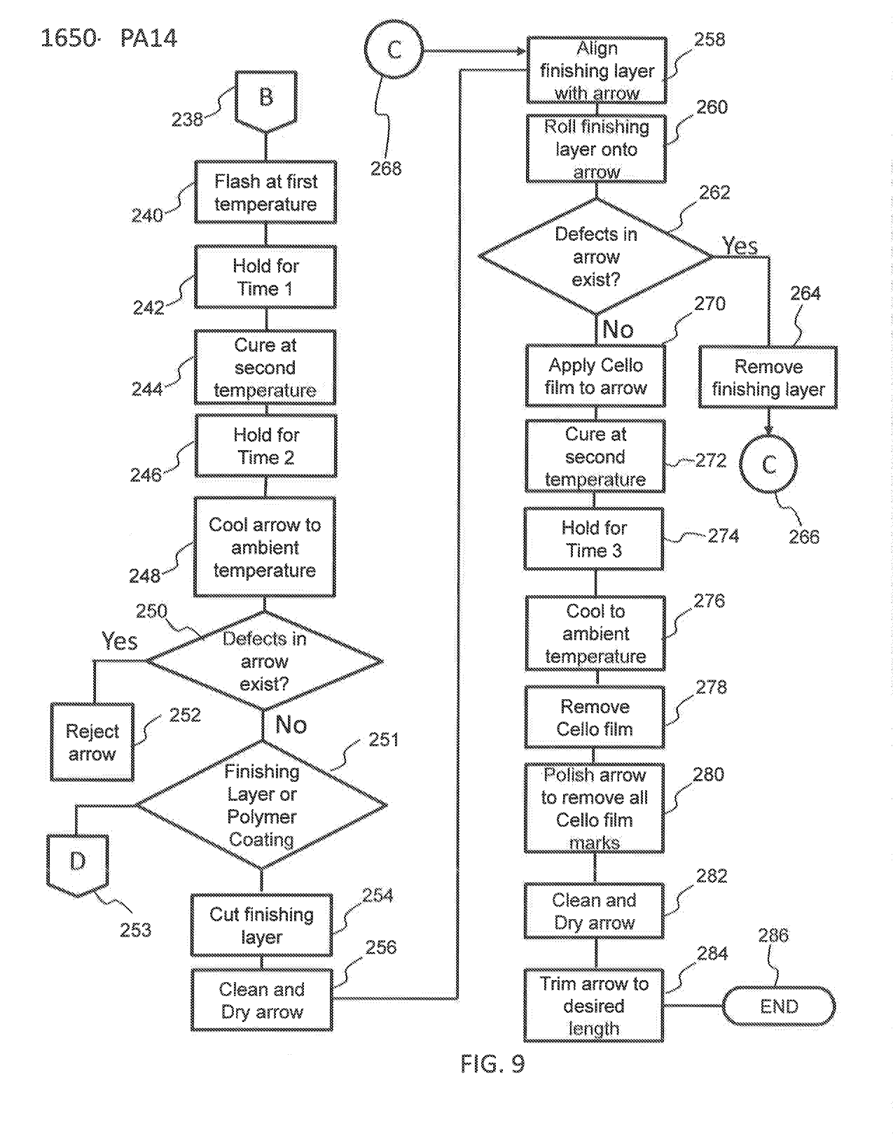

Referring now to FIG. 9, connector 238 directs the process to step 240, which has arrow 100 flashed at a first temperature to remove any moisture from arrow 100. In step 242, arrow 100 is held at the first temperature for Time 1, thirty (30) minutes. In step 244, arrow 100 is cured at a second temperature. In a preferred process, the second temperature is higher than the first temperature. Then in step 246, arrow 100 is held at the second temperature for Time 2, one (1) hour. Step 248 has arrow 100 cooled to ambient temperature. Next, in step 250, arrow 100 is inspected for defects. If a defect exists, step 252 has arrow 100 rejected. If no defects exist, the process is directed to step 251. Step 251 guides the process depending if a polymer layer or a finishing layer is used.

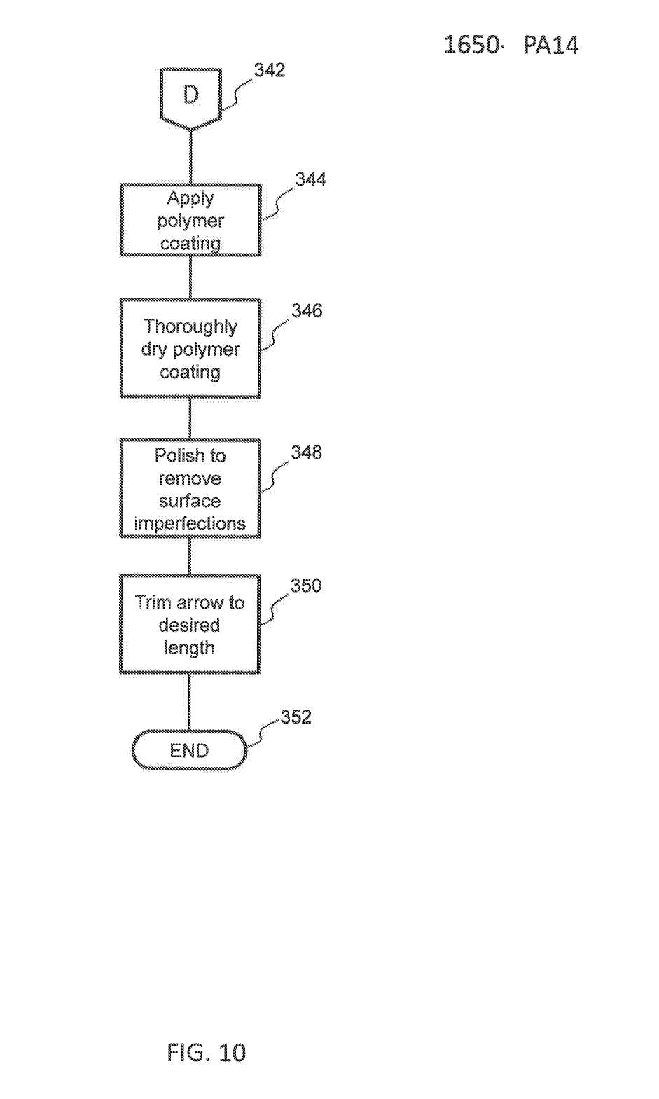

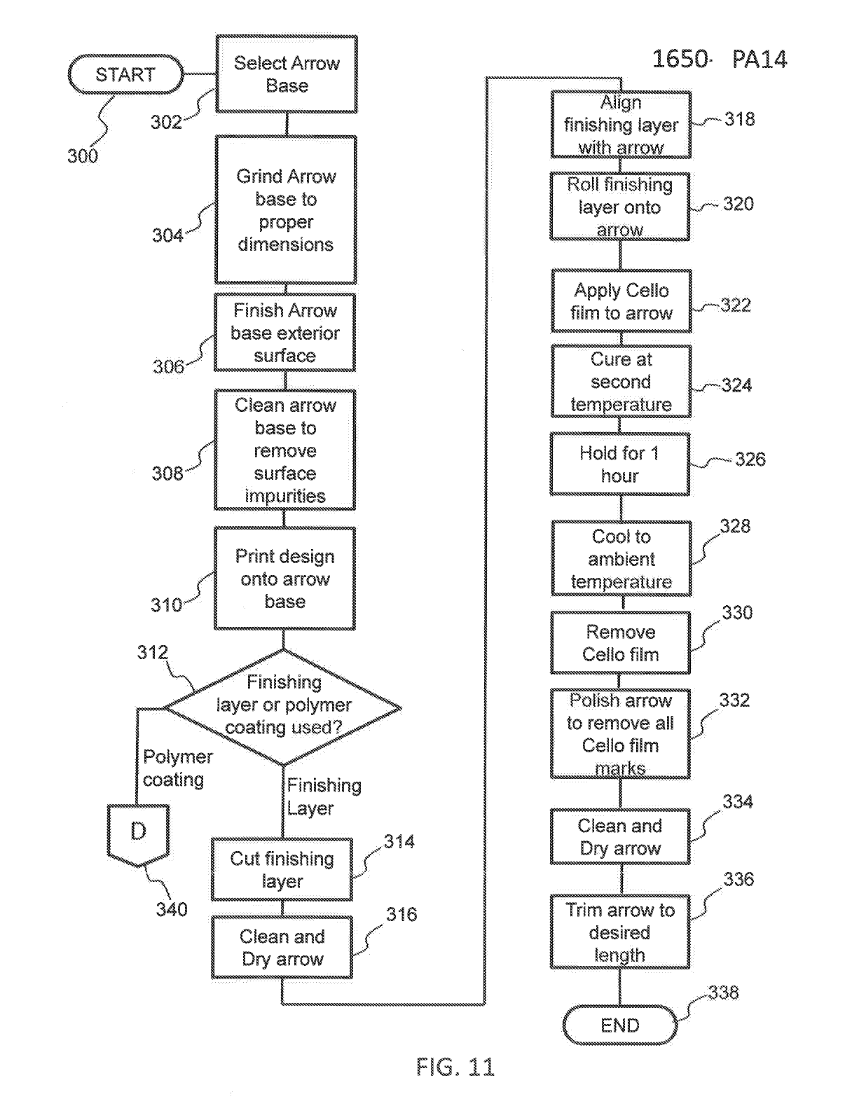

If a polymer layer is used, the process is guided to connector 253 which connects the process path to connector 342 shown in FIG. 10, which leads to step 344 where a polymer coating is applied to arrow 100. After the polymer coating is applied in step 344, the process moves to step 346 where the polymer coating is allowed to fully dry. At this point in the process, arrow 100 consists of arrow base 101, decal 110, and the polymer coating. Next, in step 348, arrow 100 is polished to remove surface imperfections in the polymer coating. Lastly, arrow 100 is trimmed to the desired length. This branch of the process ends at step 352.

Referring back to FIG. 9, if a finishing layer is used, the process is guided to step 254. In step 254, finishing layer 116 is cut to the desired dimensions. Step 256 has arrow 100 cleaned and dried. In step 258, arrow 100 is aligned with the edge of finishing layer 116. In step 260, arrow 100 is roiled to wrap finishing layer 116 around arrow 100. In step 262, arrow 100 is inspected for defects. If a defect exists, the process goes to step 264 where the finishing layer 116 is removed. Step 264 then guides the process to connector 266, which leads the process to connector 268 back to step 258 where finishing layer 116 is aligned with arrow 100. If there are no defects in arrow 100, step 262 guides the process to step 270, where arrow 100, now wrapped in finishing layer 116, is wrapped with a cellophane-like film 118 with at least one layer of film 118 covering finishing layer 116. Alternatively, the arrow 100 may be wrapped in a contracting sleeve, put inside a pressure vessel, or used with a similar device capable of imparting pressure on the arrow 100.

After arrow 100 is wrapped in step 270, or otherwise has a substantially even pressure applied to the arrow 100, the process moves to step 272 where arrow 100, finishing layer 116, and film 118 are cured at a second temperature. Step 274 has arrow 100 held at the second temperature for Time 3, one (1) hour. At the end of the hour in step 274, step 276 has arrow 100 cooled to ambient. Next, in step 278, film 118 is removed. At this point in the process, arrow 100 now consists of arrow base 101, decal 110, and finishing layer 116. In step 280, arrow 100 is polished to remove only the marks created by film 118 in finishing layer 116. Next, in step 282, arrow 100 is cleaned and dried. Lastly, in step 284, arrow 100 is trimmed to the desired length. The process then ends with step 286.

Referring now to FIG. 11, a flowchart of an alternative process of the present invention is shown. The process starts at step 300. In step 302, an arrow base 101 is selected. Next, in step 304, arrow base 101 is ground to the proper dimensions, such as diameter and spine. Step 306 has exterior surface 102 of arrow base 101 ground to a smooth finish capable of being printed upon. In step 308, arrow base 101 is cleaned to remove surface impurities. Next, in step 310, the desired design is printed onto the exterior surface of arrow base 101. At this point in the process, arrow 100 consists of arrow base 101 with the desired design printed on it.

Step 312 guides the process depending if a finishing layer or a polymer layer is used. If finishing layer 116 is used, the process is guided to step 314, where finishing layer 116 is cut to the desired dimensions. Arrow 100 is then cleaned and dried in step 316. In step 318, arrow 100 is aligned with the edge of finishing layer 116. Next, in step 320, arrow 100 is rolled until finishing layer 116 fully wraps around arrow 100. In step 322, a cellophane-like film 118 is wrapped around arrow 100 over finishing layer 116. In step 324, arrow 100 is cured. Step 326 has arrow 100 held at the curing temperature for one (1) hour. Step 328 has arrow 100 cooled to ambient. In step 330, film 118 is removed from arrow 100. Next, in step 332, arrow 100 is polished to remove undesired markings created during the curing process of steps 324 and 326. After arrow 100 is polished in step 332, the process moves to step 334 where arrow 100 is cleaned and dried. Lastly, in step 336, arrow 100 is trimmed to the desired length. Step 338 designates the end of this branch of the process.

Referring back to step 312, if a polymer coating is used, the process is directed to connector 340. Connector 340 connects the process path to connector 342 shown in FIG. 10, which leads to step 344 where a polymer coating is applied to arrow 100. After the polymer coating is applied in step 344, the process moves to step 346 where the polymer coating is allowed to fully dry. At this point in the process, arrow 100 consists of arrow base 101, the printed design, and the polymer coating. Next, in step 348, arrow 100 is polished to remove surface imperfections in the polymer coating. Lastly, arrow 100 is trimmed to the desired length. This branch of the process ends at step 352.

While the particular camouflaged arrow and the process of manufacturing such as herein shown and disclosed in detail is fully capable of obtaining the objects and providing the advantages herein before stated, it is to be understood that it is merely illustrative of the presently preferred embodiments of the invention and that no limitations are intended to the details of construction, design, and process herein shown other than as described in the appended claims,

I claim:

1. A method of manufacturing a layered graphic decal arrow comprising the steps of:
selecting an arrow base;
providing a decal mounted to a decal backing;
attaching said decal to said arrow base;
removing said decal attached to said arrow base from said decal backing;
removing imperfections from said decal attached to said arrow base;
flashing said decal attached to said arrow base at a first temperature for a first time period;
curing said decal attached to said arrow base at a second temperature for a second time period;
cooling said decal attached to said arrow base to a first ambient temperature; and
providing a finishing to said decal attached to said arrow base.

2. The method of manufacturing a layered graphic decal arrow of claim 1, wherein said first temperature is 140° F., said first time period is thirty (30) minutes, said second temperature is 210° F., and said second time period is one hour.

3. The method of manufacturing a layered graphic decal arrow of claim 2, wherein the step of providing a finishing to said decal attached to said arrow base comprises:
providing a finishing layer;
attaching said finishing layer to said arrow base with attached decal;
providing pressure on said finishing layer attached to said arrow base with attached decal;
curing said finishing layer attached to said arrow base with attached decal at a third temperature for a third time period;
cooling said finishing layer attached to said arrow base with attached decal to a second ambient temperature;
removing said pressure on said finishing layer attached to said arrow base with attached decal; and
polishing said finishing layer attached to said arrow shaft with attached decal.

4. The method of manufacturing a layered graphic decal arrow of claim 3, wherein said third temperature is 140° F. and said third time period is 1 hour.

5. The method of manufacturing a layered graphic decal arrow of claim 4, wherein the step of providing pressure on said finishing layer attached to said arrow base with attached decal comprises providing a cello film and wrapping said finishing layer attached to said arrow base with attached decal with said cell film, and wherein the step of removing said pressure on said finishing layer attached to said arrow base with attached decal comprises removing said cello film from said finishing layer attached to said arrow base with attached decal;

6. The method of manufacturing a layered graphic decal arrow of claim 4, wherein the step of providing pressure on said finishing layer attached to said arrow base with attached decal comprises providing a contracting sleeve and placing said contracting sleeve over said finishing layer attached to said arrow base with attached decal and wherein the step of removing said pressure on said finishing layer attached to said arrow base with attached decal comprises removing said contracting sleeve from said finishing layer attached to said arrow base with attached decal;

7. The method of manufacturing a layered graphic decal arrow of claim 4, wherein the step of providing pressure on said finishing layer attached to said arrow base with attached decal comprises:
providing a heated pressure vessel,
placing said finishing layer attached to said arrow base with attached decal inside said heated pressure vessel, and
applying pressure to said finishing layer attached to said arrow base with attached decal; and
wherein the step of removing said pressure on said finishing layer attached to said arrow base with attached decal comprises:
removing applied pressure from said heated pressure vessel; and
removing said finishing layer attached to said arrow base with attached decal from said heated pressure vessel.

8. The method of manufacturing a layered graphic decal arrow of claim 2, wherein the step of providing a finishing to said decal attached to said arrow base comprises:
applying a polymer coating to said arrow base with attached decal;
curing said polymer coating on said arrow base with attached decal; and
polishing said polymer coating applied to said arrow shaft with attached decal.

9. A method of manufacturing a layered graphic decal arrow comprising the steps of:
selecting an arrow base;
wetting a decal mounted to said decal backing with a solvent solution;
aligning said arrow base with said decal mounted to said decal backing;
attaching said decal to said arrow base;
removing said decal attached to said arrow base from said decal backing;
flashing said decal attached to said arrow base at a first temperature for a first time period;
curing said decal attached to said arrow base at a second temperature for a second time period;
cooling said decal attached to said arrow base to a first ambient temperature; and
providing a finishing to said decal attached to said arrow base.

10. The method of manufacturing a layered graphic decal arrow of claim 9, wherein said first temperature is 140° F., said first time period is thirty (30) minutes, said second temperature is 210° F., and said second time period is one hour.

11. The method of manufacturing a layered graphic decal arrow of claim 10, wherein the step of providing a finishing to said decal attached to said arrow base comprises;
providing a finishing layer;
attaching said finishing layer to said arrow base with attached decal;
providing pressure on said finishing layer attached to said arrow base with attached decal;
curing said finishing layer attached to said arrow base with attached decal at a third temperature for a third time period;
cooling said finishing layer attached to said arrow base with attached decal to a second ambient temperature;
removing said pressure on said finishing layer attached to said arrow base with attached decal; and
polishing said finishing layer attached to said arrow shaft with attached decal.

12. The method of manufacturing a layered graphic decal arrow of claim 11, wherein said third temperature is 140° F. and said third time period is 1 hour.

13. The method of manufacturing a layered graphic decal arrow of claim 12, wherein the step of providing pressure on said finishing layer attached to said arrow base with attached decal comprises providing a cello film and wrapping said finishing layer attached to said arrow base with attached decal with said cell film, and wherein the step of removing said pressure on said finishing layer attached to said arrow base with attached decal comprises removing said cello film from said finishing layer attached to said arrow base with attached decal;

14. The method of manufacturing a layered graphic decal arrow of claim 12, wherein the step of providing pressure on said finishing layer attached to said arrow base with attached decal comprises providing a contracting sleeve and placing said contracting sleeve over said finishing layer attached to said arrow base with attached decal and wherein the step of removing said pressure on said finishing layer attached to said arrow base with attached decal comprises removing said contracting sleeve from said finishing layer attached to said arrow base with attached decal;

15. The method of manufacturing a layered graphic decal arrow of claim 12, wherein the step of providing pressure on said finishing layer attached to said arrow base with attached decal comprises:
providing a heated pressure vessel,
placing said finishing layer attached to said arrow base with attached decal inside said heated pressure vessel, and
applying pressure to said finishing layer attached to said arrow base with attached decal; and
wherein the step of removing said pressure on said finishing layer attached to said arrow base with attached decal comprises:
removing applied pressure from said heated pressure vessel; and
removing said finishing layer attached to said arrow base with attached decal from said heated pressure vessel.

16. The method of manufacturing a layered graphic decal arrow of claim 10, wherein the step of providing a finishing to said decal attached to said arrow base comprises:
applying a polymer coating to said arrow base with attached decal;
curing said polymer coating on said arrow base with attached decal; and
polishing said polymer coating applied to said arrow shaft with attached decal.

17. A method of manufacturing a layered graphic decal arrow comprising the steps of:
selecting an arrow base;
modifying said arrow base to meet desired physical properties;
removing surface irregularities from said arrow base;
wetting a decal mounted to said decal backing with a solvent solution;
aligning said arrow base with said decal mounted to said decal backing;
attaching said decal to said arrow base;
removing said decal attached to said arrow base from said decal backing;
flashing said decal attached to said arrow base at a first temperature for a first time period;
curing said decal attached to said arrow base at a second temperature for a second time period;
cooling said decal attached to said arrow base to a first ambient temperature;
attaching a finishing layer to said arrow base with attached decal;
providing pressure on said finishing layer attached to said arrow base with attached decal;
curing said finishing layer attached to said arrow base with attached decal at a third temperature for a third time period;
cooling said finishing layer attached to said arrow base with attached decal to a second ambient temperature;
removing said pressure on said finishing layer attached to said arrow base with attached decal; and
polishing said finishing layer attached to said arrow shaft with attached decal.

18. The method of manufacturing a layered graphic decal arrow of claim 17, wherein the step of providing pressure on said finishing layer attached to said arrow base with attached decal comprises providing a cello film and wrapping said finishing layer attached to said arrow base with attached decal with said cell film, and wherein the step of removing said pressure on said finishing layer attached to said arrow base with attached decal comprises removing said cello film from said finishing layer attached to said arrow base with attached decal;

19. The method of manufacturing a layered graphic decal arrow of claim 17, wherein the step of providing pressure on said finishing layer attached to said arrow base with attached decal comprises providing a contracting sleeve and placing said contracting sleeve over said finishing layer attached to said arrow base with attached decal and wherein the step of removing said pressure on said finishing layer attached to said arrow base with attached decal comprises removing said contracting sleeve from said finishing layer attached to said arrow base with attached decal;

20. The method of manufacturing a layered graphic decal arrow of claim 17, wherein the step of providing pressure on said finishing layer attached to said arrow base with attached decal comprises:
providing a heated pressure vessel,
placing said finishing layer attached to said arrow base with attached decal inside said heated pressure vessel, and
applying pressure to said finishing layer attached to said arrow base with attached decal; and
wherein the step of removing said pressure on said finishing layer attached to said arrow base with attached decal comprises:
removing applied pressure from said heated pressure vessel; and
removing said finishing layer attached to said arrow base with attached decal from said heated pressure vessel
